(19) United States
(12) Patent Application Publication
(10) Pub. No.: US 2015/0101356 A1
(43) Pub. Date: Apr. 16, 2015

(54) HEAT EXCHANGER HAVING THERMOELECTRIC ELEMENT AND METHOD FOR MANUFACTURING THE SAME

(71) Applicants: KBAUTOTECH CO., LTD., Asan (KR); Hyundai Motor Company, Seoul (KR)

(72) Inventors: Man Ju Oh, Yongin (KR); Jae Woong Kim, Hwaseong (KR); Jae Woo Park, Ansan (KR); Jae Hoon Kim, Cheonan (KR)

(73) Assignees: KBAUTOTECH CO., LTD., Asan (KR); HYUNDAI MOTOR COMPANY, Seoul (KR)

(21) Appl. No.: 14/134,274

(22) Filed: Dec. 19, 2013

(30) Foreign Application Priority Data
Oct. 11, 2013 (KR) 10-2013-0121231

(51) Int. Cl. F25B 21/02; B23P 15/26

(52) U.S. Cl. CPC F25B 21/02; B23P 15/26
USPC 62/3.7; 29/890.046

(57) ABSTRACT

A heat exchanger with a thermoelectric element having a tubular fluid channel extending in a longitudinal direction is provided. In particular, the fluid channel is bent at a middle portion to have a first portion and a second portion on both sides of the middle portion, and has an inlet and an outlet for entry and exit of fluid. Also included is a thermoelectric element that has a first surface of which is attached to a first section of a first surface of a flat portion of the first portion and the second portion of the fluid channel, and a radiant heat fin attached to the first surface and a second surface of each of the first portion and the second portion of the fluid channel, respectively. Further disclosed is a method for manufacturing the heat exchanger.

### CROSS-REFERENCE TO RELATED APPLICATION

This application claims under 35 U.S.C. §119(a) the benefit of Korean Patent Application No. 10-2013-0121231 filed Oct. 11, 2013, the entire contents of which are incorporated herein by reference.

### BACKGROUND OF THE INVENTION

1. Field of the Invention

The present invention relates to a heat exchanger with a thermoelectric element which is compact in size, can be easily manufactured, and has improved heat-exchanging efficiency, and a method for manufacturing the same.

2. Description of the Related Art

Conventionally, flat plate heat exchangers with a thermoelectric element have been used. Flat plate heat exchangers have a radiant heat structure in which a coolant channel is formed on one side of a flat panel and an air fin is installed at the opposite side of the flat panel.

This structural configuration, however, is excessively heavy and thus can affect fuel efficiency if it is applied to vehicular systems. In addition, the thickness of this structural configuration is also not easily reduced, which may cause overheating of the internal elements (such as the thermal electric component).

One alternative to the above described flat plate heat exchanger is a core heat exchanger. In the core heat exchanger, pipes are disposed on both sides of a plate and a plurality of tubes are connected between the pipes. A thermoelectric element is positioned above the tube and a radiant heat fin in an air-channel side is positioned above the thermoelectric element. During assembly of the core heat exchanger, however, the core cannot be assembled until the thermoelectric element is completely assembled. As a result the assembly of core heat exchangers is difficult and thus there is wide variation in quality of products.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a heat exchanger with a thermoelectric element which is compact in size, can be easily manufactured, and has improved heat-exchanging efficiency, and a method for manufacturing the same.

In order to achieve the above object, according to one aspect of the present invention, there is provided a heat exchanger with a thermoelectric element, including: a fluid channel which is tubular and extending in a longitudinal direction, is bent at a middle portion to have a first portion and a second portion abutting each end of the middle portion respectively, and has an inlet and an outlet for inflow and discharge of working fluid (e.g., oil, refrigerant; water, etc.) at ends of the first portion and second portion, respectively. Also included is a thermoelectric element, a first surface of which is attached to at least a first section of a first surface of a flat portion of the first portion and the second portion of the fluid channel, and a radiant heat fin attached to a second section of the first surface and a second surface of each of the first portion and the second portion of the fluid channel, respectively.

In some exemplary embodiments, the fluid channel may be bent at the middle portion so that the first portion and the second portion may face each other. Likewise, the inlet and outlet of the fluid channel may be positioned to face each other and may be aligned in line with each other.

As stated above, the fluid channel may be bent at the middle portion. In doing so, a distance between the first portion and the second portion is more than two times than a height of the radiant heat fin. It may be beneficial therefore, that in the fluid channel, only the middle portion is a bent portion and the first portion and the second portion are flat portions.

Furthermore, the thermoelectric element may be attached to a first surface and a second surface of each of the first portion and the second portion and/or to the end of the second portion of the fluid channel, at which the outlet is formed.

The thermoelectric element may also be attached to first surfaces of the first portion and the second portion respectively where these respective first surfaces face each other, and a heat insulating member may be attached to second surfaces of the first portion and the second portion respectively, where these respective second surfaces are opposite the first surfaces.

The heat insulating member, in some exemplary embodiments of the present invention, may extend from the first portion of the fluid channel to the middle portion, and up to the second portion. As such, the heat insulating member may be disposed to surround the fluid channel.

The radiant heat fin, in the some exemplary embodiments of the present invention, may be attached to the fluid channel while extending up to and covering a second surface of the thermoelectric element when the first surface of the thermoelectric element is attached to the fluid channel.

The heat exchanger may further include a housing which surrounds outside surfaces of the fluid channel and is provided with an entrance hole and an exit hole so that fluid to be heat exchanged passes over the radiant heat fin. In the housing, a shielding portion may be provided, along a longitudinal direction of the first portion and second portion, in order to prevent the first portion and the second portion of the fluid channel from being exposed and cause the fluid to be heat exchanged only to pass over the radiant heat fin.

Additionally, in some exemplary embodiments, the middle portion of the fluid channel which is bent may be exposed through an opening of the housing so that the middle portion is not contact with fluid to be heat exchanged.

In another exemplary embodiment of the present invention, in order to achieve the above object, according to another aspect of the present invention, there is provided a heat exchanger with a thermoelectric element, including, a fluid channel which is tubular extending in a longitudinal direction, is bent at a middle portion to have a first portion and a second portion abutting both ends of the middle portion respectively, and has an inlet and an outlet for inflow and discharge of working fluid at ends of the first portion and second portion, respectively; and a thermoelectric element attached to a first surface of the first portion or the second portion.

In order to achieve the above object, according to a further aspect of the present invention, there is provided a heat exchanger with a thermoelectric element, including: a fluid channel which is tubular extending in a longitudinal direction, is bent at a middle portion such that a first portion and a second portion abutting both ends of the middle portion face each other, and has an inlet and an outlet aligned to be in line with each other, and a thermoelectric element attached to a first surface and a second surface of the first portion or the second portion.

In order to achieve the above object, according to a yet a further aspect of the present invention, there is a method for manufacturing a heat exchanger with a thermoelectric element, including: attaching a first surface of a thermoelectric element to a plate-like fluid channel; attaching a radiant heat fin to a first surface and a second surface of each of a first portion and a second portion; and bending a middle portion of the fluid channel.

While the bending the middle portion, the middle portion may be bent such that a distance between the first portion and the second portion is more than two times than a height of the radiant heat fin.

Advantageously, according to the heat exchanger with a thermoelectric element and the method for manufacturing a heat exchanger with a thermoelectric element which are described above, the total thickness of the tubular structure can be significantly reduced compared with conventional flat plate heat exchangers, and thus thermal resistance on the coolant side of the heat exchanger is decreased. Accordingly, overheating of the thermoelectric element is prevented, and thus durability and heat-exchanging efficiency are improved. Furthermore, the weight of the heat exchanger can be significantly reduced.

Along the lines of manufacturing, the thermoelectric element and the radiant heat fin are separate parts and thus can be easily assembled. This results in an increased product quality, especially the quality in joined portions, and thus productivity is increased as a result of this manufacturing process reduction. Finally, since only one tube is used, mold costs and raw material costs are reduced as well.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a heat exchanger with a thermoelectric element according to one exemplary embodiment of the present invention;

FIGS. 2 to 4 are diagrams illustrating a method for manufacturing a heat exchanger with a thermoelectric element according to one exemplary embodiment of the present invention; and

FIGS. 5 through 7 are cross-sectional views illustrating heat exchangers with a thermoelectric element according diverse exemplary embodiments of the present invention.

### DETAILED DESCRIPTION OF THE INVENTION

Hereinbelow, a heat exchanger with a thermoelectric element and a method for manufacturing the same according to preferred embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

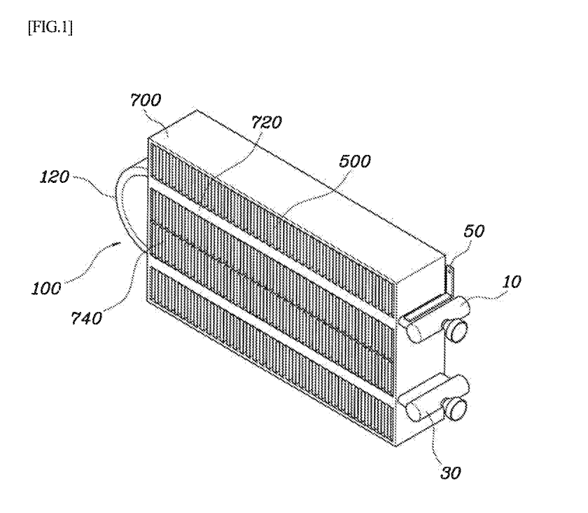

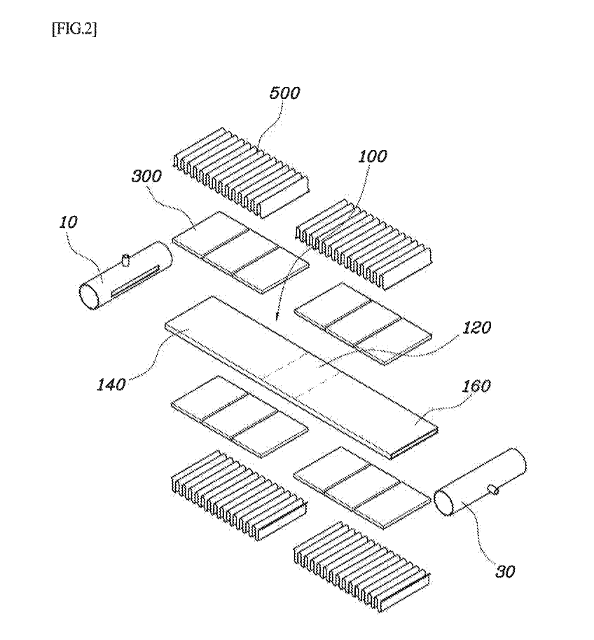

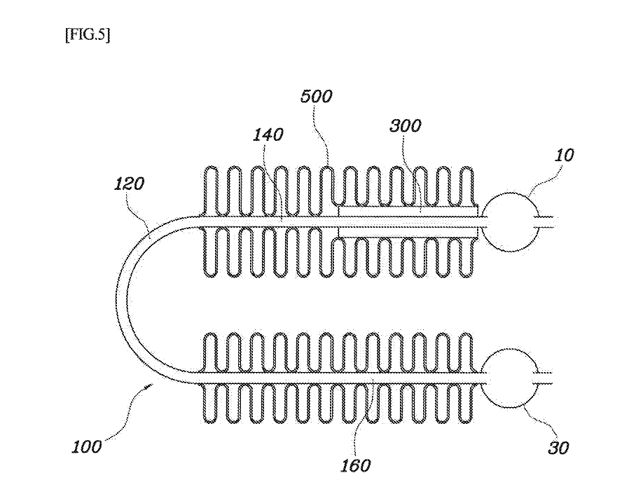

FIG. 1 is a perspective view illustrating a heat exchanger with a thermoelectric element according to one exemplary embodiment of the present invention; FIGS. 2 to 4 are diagrams illustrating a method for manufacturing a heat exchanger with a thermoelectric element according to one embodiment of the present invention; and FIGS. 5 through 7 are cross-sectional views illustrating heat exchangers with a thermoelectric element according diverse embodiments of the present invention.

FIG. 1 is a perspective view illustrating the heat exchanger with a thermoelectric element according to one exemplary embodiment of the present invention. The heat exchanger with a thermoelectric element according to the present embodiment includes a fluid channel 100 which is a plate-like tubular structure extending in a longitudinal direction. The fluid channel 100 is bent in a middle portion 120. A first end of the fluid channel 100 is provided with an inlet 30 for intake of working fluid and a second end of the fluid channel 100 is provided with an outlet 10 for discharge of the working fluid. The heat exchanger further includes a thermoelectric element 300 (FIGS. 2-6) and a radiant heat fin 500. A first surface of the thermoelectric element 300 is attached to a first section of a first surface of a flat surface of a first portion 160 (FIGS. 2.6) and a second portion 140 (FIGS. 2-6) of the fluid channel 100. The radiant heat fin 500 is attached to at least a second section of a first surface and a second surface of each of the first portion 160 and the second portion 140 of the fluid channel 100, respectively.

Since the fluid channel 100 is formed using only one flat plate tubular structure with at least two flat surfaces, manufacturing costs are reduced. The fluid channel 100 is bent in one position, i.e., approximately at the middle portion 120 so that the inlet 30 and the outlet 10 are in line with each other (i.e., formed along the same axis). This simplifies the layout of the heat exchanger and reduces the amount of spaced occupied by the heat exchanger. This also facilitates the design of the coolant pipes, and thus reduces manufacturing costs and improves marketability.

In the thermoelectric element 300, one surface (for example, the first surface) performs air conditioning using a positive electrode and the other surface (for example, the second surface) functions to dissipate or receive heat. That is, the first surface and the second surface of the thermoelectric element 300 function as an air-conditioning surface and a radiant-heat surface, respectively. Switching between electric polarities changes the functions of the surfaces of the thermoelectric element 300. When performing cooling using the thermoelectric element 300, a key point is to discard the heat through the opposite surface. Accordingly, a first surface of the thermoelectric element 300 is attached to a first surface of the fluid channel 100, and the radiant heat fin 500 is attached to a second surface, opposite to the first surface, of the thermoelectric element 300. In this way, an effective air conditioning process is carried out.

Ends of the first portion and the second portion of the fluid channel 100 are provided with the inlet 30 and the outlet 10 for working fluid, respectively. The radiant heat fin 500 is attached to the first and second surfaces of each of the first portion 160 and the second portion 140 of the fluid channel 100. Through this structure, while heating, the thermoelectric element 300 not only removes the heat in the coolant through the radiant heat fin 500 but also generates electrical resistance heat, thereby heating a large amount of air through the radiant heat fin 500 and thus heating a space accordingly.

During cooling, the heat transferred to the radiant heat fin 500 is transferred toward the coolant through the thermoelectric element 300 so that the heat is discarded. The heat passing through the radiant heat fin 500 is then cooled down so that a space is cooled.

Specifically, the fluid channel 100 is bent only once at the middle portion 120 so that the first portion 160 and the second portion 140 may face each other. The inlet 30 and outlet 10 of the fluid channel 100 are aligned in line with each other (i.e., along the same axis). As such, this structure can simplify the arrangement of pipes through which coolant flows, thereby reducing the volume (size) of the heat exchanger. So, installation spaces where the heat exchanger can be installed are not limited as a result of the exemplary embodiment of the present invention. This structure is especially useful when installing an air conditioning mechanism in a small space such as on a high voltage battery for a vehicle.

FIGS. 2 to 4 are diagrams illustrating a method for manufacturing a heat exchanger with a thermoelectric element according to one exemplary embodiment of the present invention. The method includes attaching at least one surface of a thermoelectric element 300 to a flat plate fluid channel 100, attaching a radiant heat fin 500 to respective surfaces (or sections of the surfaces) of a first portion 160 and a second portion 140 of the fluid channel 100 respectively, and bending (e.g., only once) a middle portion 120 of the fluid channel 100 until the first portion and the second portion are substantially parallel to each other. During bending of the middle portion 120 of the fluid channel 100, a distance between the first portion 160 of the fluid channel 100 and the second portion 140 of the fluid channel 100 is set to be two times the height of the radiant heat fin 500.

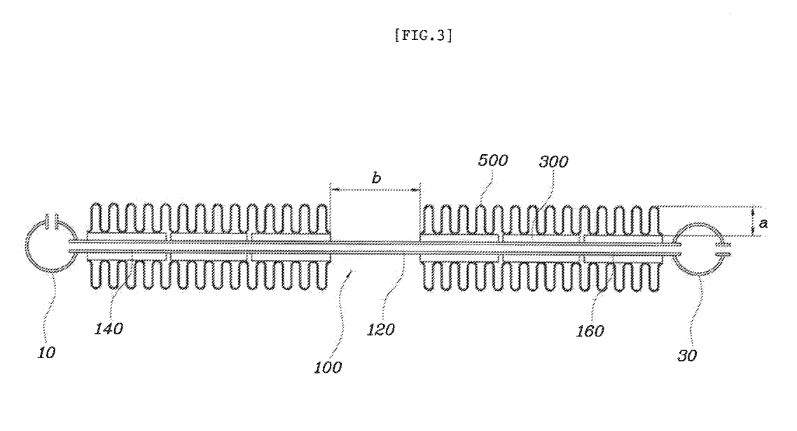

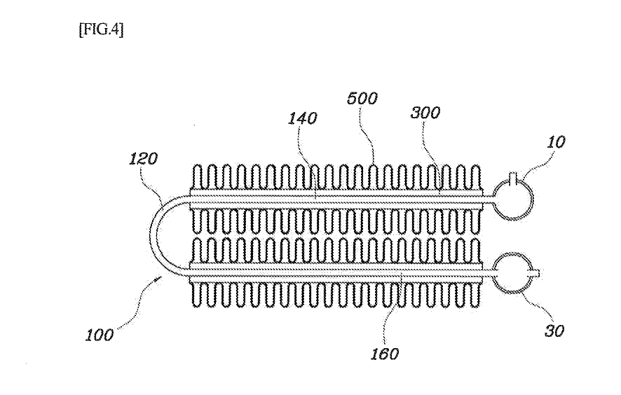

First, as illustrated in FIG. 2, at least one surface (or preferably only one surface) of the thermoelectric element 300 is attached to the fluid channel 100 which is not bent but has a flat plate structure. Next, the radiant heat fin 500 is attached to first and second surfaces of each of the first portion 160 and the second portion 140 of the fluid channel 100. The assembly state after this step is shown in FIG. 3. Next, the middle portion 120 of the fluid channel 100 is bent and thus the assembly of the heat exchanger is completed as illustrated in FIG. 4.

The middle portion 120 is bent such that the distance between the first portion 160 of the fluid channel 100 and the second portion 140 of the fluid channel 100 is more than two times than the height of the radiant heat fin 500. Thus, as illustrated in FIG. 4, the radiant heat fin 500 is disposed such that a part of the radiant heat fin 500 on the surface of the first portion 160 and another part of the radiant heat fin 500 on the surface of the second portion 140 face each other while being disposed between the first portion 160 and the second portion 140.

This structure prevents stress from concentrating on a junction where the thermoelectric element 300 is attached, arranges the inlet and outlet for coolant at adjacent positions, and concentrically arranges the radiant heat fin 500 in a position through which air passes. This structure results in a simplified layout.

Preferably, the fluid channel 100 is bent only at the middle portion 120, and the first portion 160 and the second portion 140 each have a flat plate shape running substantially parallel to each other. As such, the thermoelectric element 300 can be attached to one surface and the other surface of each of the first portion 160 and the second portion 140 of the fluid channel 100.

In addition, as illustrated in FIG. 1, the heat exchanger may further include a housing 700 which encloses the fluid channel 100 and is provided with an entrance hole 740 and an exit hole through which fluid to be heat-exchanged can be introduced into and discharged from the housing after passing along the radiant heat fin 500. Shielding portions 720 extending along a longitudinal direction of the first portion 160 and the second portion 140 are provided in the housing 700 in order to prevent the first portion 160 and the second portion 140 of the fluid channel 100 from being exposed. This causes air to be heat-exchanged to pass by only the radiant heat fin 500. The air to undergo the heat exchanging process only passes by the radiant heat fin 500 and air conditioning is effectively performed as a result, without being affected by the surface of the thermoelectric element 300 and the fluid channel 100.

Additionally, the middle portion 120 of the fluid channel 100 may pass through the housing 700 so that the middle portion 120 may be exposed to the outside and may not come into contact with fluid to be heat-exchanged. For this reason, the air to be heat-exchanged is not affected by the fluid channel 100.

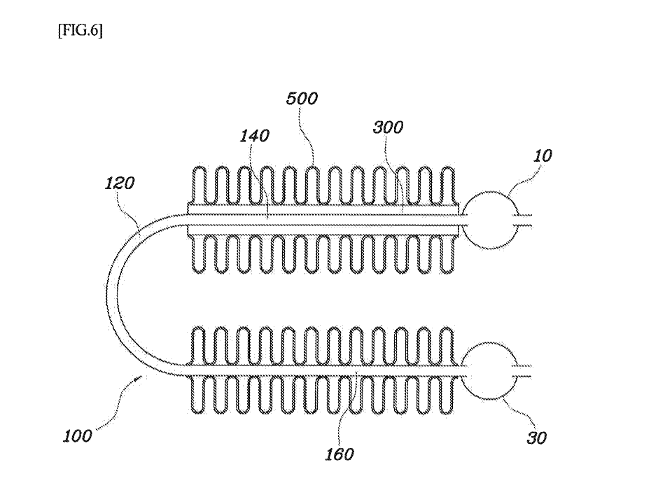

FIGS. 5 through 7 are cross-sectional views illustrating heat exchangers with a thermoelectric element according diverse embodiments of the present invention. As illustrated in FIG. 5 or 6, a thermoelectric element may be attached to a second portion of a fluid channel, at an end of which an outlet for fluid is formed. Even in this case, a radiant heat fin 500 extends to cover a second surface of the thermoelectric element 300 when a first surface of the thermoelectric element 300 is attached to a fluid channel 100. In this case, the heat exchanger can be effectively used when a reduced amount of cooling is required.

Coolant which is cooled by a radiator separately installed cools the air in a position where the thermoelectric element 300 is not positioned, and the cooling is smoothly carried out in the position at which the thermoelectric element 300 is positioned. Furthermore, since the thermoelectric element 300 is positioned in the second portion 140 or at a second end portion of the fluid channel 100 from which the coolant is discharged, even though heat is eventually transferred to the coolant this heat transfer does not affect the air in terms of the overall cooling performance.

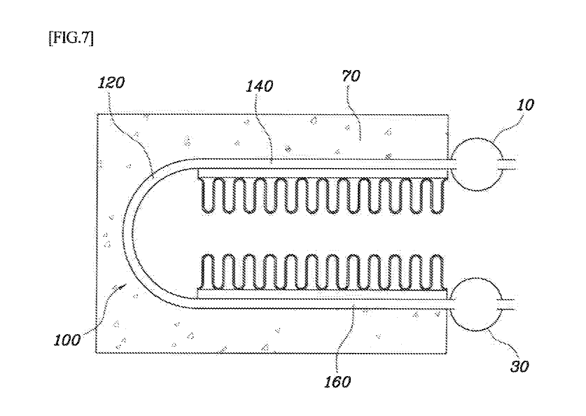

In addition, as illustrated in FIG. 7, among the surfaces of the fluid channel 100, the thermoelectric element 300 may be attached to surfaces (i.e., inside surfaces) of a first portion 160 and a second portion 140 which face each other, and a heat insulating member 70 may be attached to the opposite surfaces (i.e., outside surfaces) of the first portion 160 and the second portion 140. The heat insulating member 70 may extend from an end of the first portion 160 of the fluid channel 100, to a middle portion 120, and up to and abutting an end of the second portion 140 of the fluid channel, thereby surrounding the outside surfaces of the fluid channel 100.

This structure is used when air should be circulated in a small space. In this case, the thermoelectric element 300 is attached to the surfaces of the first portion 160 and the second portion 140 which face each other, a radiant heat fin 500 is attached to the remaining surface of the thermoelectric element 300. Accordingly, cooling or heating of air is performed, without being influenced by external disturbance, in part to the heat insulating member 70 attached to the outside surfaces of the fluid channel 100. Since the heat insulating member 70 extends from the end of the first portion 160 of the fluid channel 100, to the middle portion 120, and up to and abutting the end of the second portion 140 of the fluid channel 100, and thus surrounds the outside surfaces of the fluid channel 100, improved heat insulation is achieved and external disturbance does not influence the heat exchange process in the heat exchanger.

Advantageously, according to the heat exchanger with a thermoelectric element and the method for manufacturing a heat exchanger with a thermoelectric element which are described above, the total thickness of the tubular structure can be significantly reduced compared with conventional flat plate heat exchangers, and thus thermal resistance on the coolant side of the heat exchanger is decreased. Accordingly, overheating of the thermoelectric element is prevented, and thus durability and heat-exchanging efficiency are improved. Furthermore, the weight of the heat exchanger can be significantly reduced.

Along the lines of manufacturing, the thermoelectric element and the radiant heat fin are separate parts and thus can be easily assembled. This results in an increased product quality, especially the quality in joined portions, and thus productivity is increased as a result of this manufacturing process reduction. Finally, since only one tube is used, mold costs and raw material costs are reduced as well.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A heat exchanger with a thermoelectric element, comprising:
a tubular fluid channel extending in a longitudinal direction, bent at a middle portion to have a first portion and a second portion at both sides of the middle portion, respectively, and having an inlet and an outlet to intake and discharge a fluid at ends of the first portion and the second portion, respectively;
a thermoelectric element, a fast surface of which is attached to a first section of a first surface of a flat surface of the first portion and the second portion of the fluid channel; and
a radiant heat fin attached to at least a second section of the first surface and a second surface of each of the first portion and the second portion of the fluid channel.

2. The heat exchanger with the thermoelectric element according to claim 1, wherein the fluid channel is bent at a middle portion of the fluid channel so that respective surfaces of the fast portion and second portion face each other.

3. The heat exchanger with the thermoelectric element according to claim 2, wherein the inlet and outlet of the fluid channel face each other and are aligned to be in line with each other.

4. The heat exchanger with the thermoelectric element according to claim 2, wherein the fluid channel is bent at the middle portion and a distance between the first portion and the second portion is more than two times a height of the radiant heat fin.

5. The heat exchanger with the thermoelectric element according to claim 1, wherein the fluid channel is bent only once at a middle portion of the fluid channel, and the first portion and the second portion have a flat plate shape.

6. The heat exchanger with the thermoelectric element according to claim 1, wherein the thermoelectric element is attached to respective surfaces of each of the first portion and the second portion of the fluid channel.

7. The heat exchanger with the thermoelectric element according to claim 1, wherein the thermoelectric element is attached to the second portion of the fluid channel, at an end of which an outlet is formed.

8. The heat exchanger with the thermoelectric element according to claim 1, wherein the thermoelectric element is attached to first surfaces of the first portion and the second portion, the first surfaces facing each other, and a heat insulating member is attached to second surfaces of the first portion and the second portion, the second surfaces being opposite the first surfaces.

9. The heat exchanger with the thermoelectric element according to claim 8, wherein the heat insulating member extends from the first portion of a fluid channel to the middle portion, and up to the second portion, in a manner of surrounding the fluid channel.

10. The heat exchanger with the thermoelectric element according to claim 1, wherein the radiant heat fin is attached to the fluid channel while extending up to and covering a second surface of the thermoelectric element in a state where the first surface of the thermoelectric element is attached to the fluid channel.

11. The heat exchanger with the thermoelectric element according to claim 1, further comprising a housing which surrounds outside surfaces of the fluid channel and is provided with an entrance hole and an exit hole so that fluid to be heat exchanged passes by the radiant heat fin.

12. The heat exchanger with the thermoelectric element according to claim 11, wherein a shielding portion is provided, along a longitudinal direction of the first portion and second portion, in the housing in order to prevent the first portion and the second portion of the fluid channel from being exposed and cause fluid to be heat exchanged to only pass by the radiant heat fin.

13. The heat exchanger with the thermoelectric element according to claim 1, wherein the middle portion of the fluid channel is exposed through the housing so that the middle portion does not come into contact with fluid.

14. A heat exchanger with a thermoelectric element, comprising:
a fluid channel which has a tube shape extending in a longitudinal direction, is bent at a middle portion thereof and has an inlet and an outlet for inflow and discharge of working fluid at a first end and a second end thereof, respectively;
a thermoelectric element, a first surface of which is attached to a first surface of a flat portion within the first portion and the second portion of the fluid channel; and
a radiant heat fin attached to one surface of the first portion or the second portion of the fluid channel.

15. A heat exchanger with a thermoelectric element, comprising:
a tubular plate-like fluid channel extending in a longitudinal direction, the fluid channel including a first portion and a second portion having an inlet and an outlet for intake and discharge of fluid, respectively, wherein the fluid channel is bent in a middle portion such that the first portion and the second portion face each other and that the inlet and the outlet are aligned in line with each other at one end of the heat exchanger;
a thermoelectric element, a first surface of which is attached to a first section of first surface of a flat surface of the first portion and the second portion of the fluid charnel, respectively; and
a radiant heat fin attached to the first surface and a second surface of each of the first portion and the second portion of the fluid channel.

16. A method for manufacturing the heat exchanger of claim 1, comprising:
attaching a first surface of a thermoelectric element to a plate-like fluid channel including a first portion and a second portion;
attaching a radiant heat fin to a first surface and a second surface of each of the fast portion and the second portion; and
bending a middle portion of the fluid channel until the first portion and the second portion are substantially parallel to teach other.

17. The method according to claim 16, wherein in the bending of the middle portion, a distance between the first portion and the second portion is more than two times than a height of the radiant heat fin.
